(19) United States
(12) Patent Application Publication
(10) Pub. No.: US 2006/0226812 A1
(43) Pub. Date: Oct. 12, 2006

(54) Method and system for charging batteries with improved cycle life

(76) Inventors: Joseph Patino, Pembroke Pines, FL (US); Russell L. Simpson, Miami, FL (US)

Correspondence Address: MOTOROLA, INC., LAW DEPARTMENT, 1303 E. ALGONQUIN ROAD, SCHAUMBURG, IL, 60196, US

(21) Appl. No.: 11/093,631

(22) Filed: Mar. 30, 2005

(51) Int. Cl. H02J 7/00

(52) U.S. Cl. 320/128

(57) ABSTRACT

A battery charging method (20) can include the steps of setting (20) a maximum charge voltage for a battery (104) and dynamically adjusting (38) the maximum charge voltage for the battery based on at least one among an amount of time the battery is maintained at the maximum charge voltage and an amount of cycles the battery is charged to the maximum charge voltage. The method can further include the step of measuring (36) a temperature of the battery and further dynamically adjusting (38) the maximum charge voltage for the battery based on the temperature of the battery, and/or timer value and/or counter value. Furthermore, the method can also include the step of updating (130) at least one among a counter and a timer each time after a charge is complete.

### FIELD OF THE INVENTION

This invention relates generally to battery charging, and more particularly to an algorithm and system for improving battery cycle life during extended battery charging.

### BACKGROUND OF THE INVENTION

Maintaining a battery at full charge for an extended period of time adversely affects cycle life capacity performance. The adverse effect of elevated temperature on battery cycle life is also well known. A common practice among users of charging devices is to leave the battery in the charger for an extended period of time, well beyond the time of a completed charge. Unfortunately, such practice is detrimental to the cycle life of the battery since many chargers continue to charge again after a complete charge after the battery falls below a maximum charge voltage threshold. Such scenario fails to preserve the battery cycle life performance of a battery particularly when the battery remains in a charger for an extended period of time.

### SUMMARY OF THE INVENTION

Embodiments in accordance with the present invention can provide a system, method or algorithm which can dynamically adjust the maximum charge voltage (Vmax, typically 4.2V) based on a length of time that a battery is left in a charger and held at Vmax and/or by a number of recharge cycles to the battery. In addition, temperature can be measured and taken into account to adjust Vmax accordingly. For example, at higher temperatures, Vmax is reduced to minimize the thermal effect on cycle life capacity.

In a first embodiment of the present invention, a battery charging method can include the steps of setting a maximum charge voltage for a battery and dynamically adjusting the maximum charge voltage for the battery based on at least one among an amount of time the battery is maintained at the maximum charge voltage and an amount of cycles the battery is charged to the maximum charge voltage. The method can further include the step of measuring a temperature of the battery and further dynamically adjusting the maximum charge voltage for the battery based on the temperature of the battery. Such technique can help maintain the battery at an acceptable charge level below the maximum charge voltage while minimizing cycle life effects of elevated voltage and temperature. In one embodiment, the method can involve setting a threshold for one among a counter and a timer and clearing at least one among the counter and the timer once a battery is removed or placed into a charger using the method. Furthermore, the method can also include the step of updating at least one among a counter and a timer each time after a charge is complete.

In a second embodiment of the present invention, another battery charging method can include the steps of setting a maximum charge voltage for a battery, setting a threshold for a timer or counter, charging the battery, incrementing a timer or counter each time when charging of the battery is complete, charging the battery again if a battery voltage for the battery falls below a recharge voltage threshold and the timer or counter fails to exceed the (timer or counter) threshold, and adjusting the maximum charge voltage before charging the battery again if the battery voltage for the battery falls below the recharge voltage threshold and the timer or counter exceeds the threshold. The method can further include the step of measuring a temperature if the timer or counter exceeds the threshold and adjusting the maximum charge voltage based on a timer or counter value and the temperature measured or alternatively adjusting the maximum charge voltage based on just a timer or counter value measured. The method can further include the step of clearing at least one among the timer and the counter before a first charge of the battery.

In a third embodiment of the present invention, a battery charging system can include a charger coupled to at least one among a timer and a counter and a processor coupled to the charger. The processor can be programmed to set a maximum charge voltage for a battery and dynamically adjust the maximum charge voltage for the battery based on at least one among an amount of time the battery is maintained at the maximum charge voltage and an amount of cycles the battery is charged to the maximum charge voltage. The processor can also clear at least one among a timer and a counter before a charge of the battery. The processor can be further programmed to measure a temperature of the battery, particularly if at least one among a timer or a counter exceeds a threshold value. In this regard, the processor can further be programmed to dynamically adjust the maximum charge voltage for the battery based on at least one among a timer value, a counter value and the temperature of the battery measured. Note, the processor can also be programmed to maintain the battery at an acceptable charge level below the maximum charge voltage while minimizing cycle life effects of elevated voltage and temperature.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart of an existing algorithm for charging a rechargeable battery.

FIG. 2 is a flow chart illustrating a method of improving cycle life for rechargeable batteries in accordance with an embodiment of the present invention.

FIG. 3 is a block diagram of a device utilizing a charging system in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures.

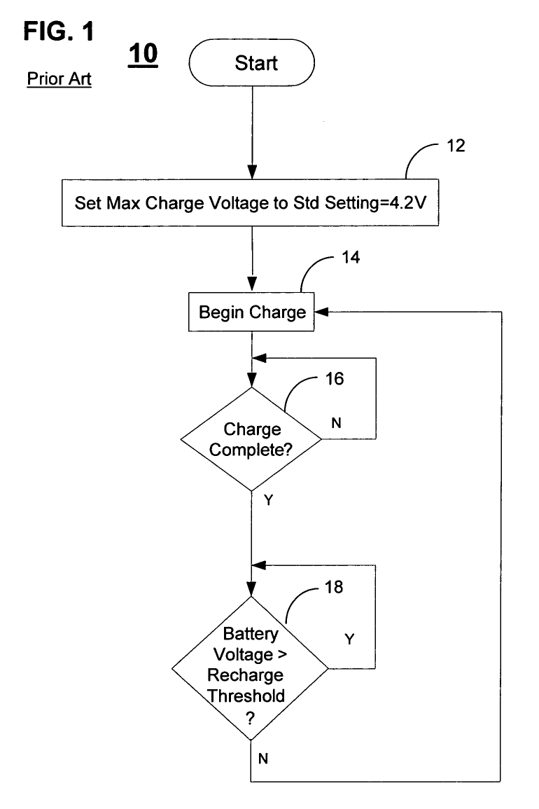

When a battery is left in an existing conventional charger for an extended period of time, the conventional charger will continue to recharge the battery each time the battery voltage drops below a (recharge) voltage threshold or at pre-set time interval (or the conventional charger can discontinue charging causing a unacceptable capacity level). Referring to FIG. 1, a flow chart illustrating a method 10 represents a typical conventional charge/recharging technique where a maximum charge voltage is set (typically to 4.2 volts) at step 12 and charging begins at step 14. The charger continues to charge until the charging is complete at step 16. Once the charging cycle is complete, the charger monitors the battery voltage at step 18. As noted above, if the battery voltage drops below a recharge voltage threshold at step 18, then the method 10 returns to begin charging the battery again at step 14. While this method 10 maintains the battery charge at close to maximum capacity, the long term effect on the battery is reduced capacity. The effects of extended exposure to elevated voltage and temperature are unmistakable as data taken from weeks of testing has confirmed.

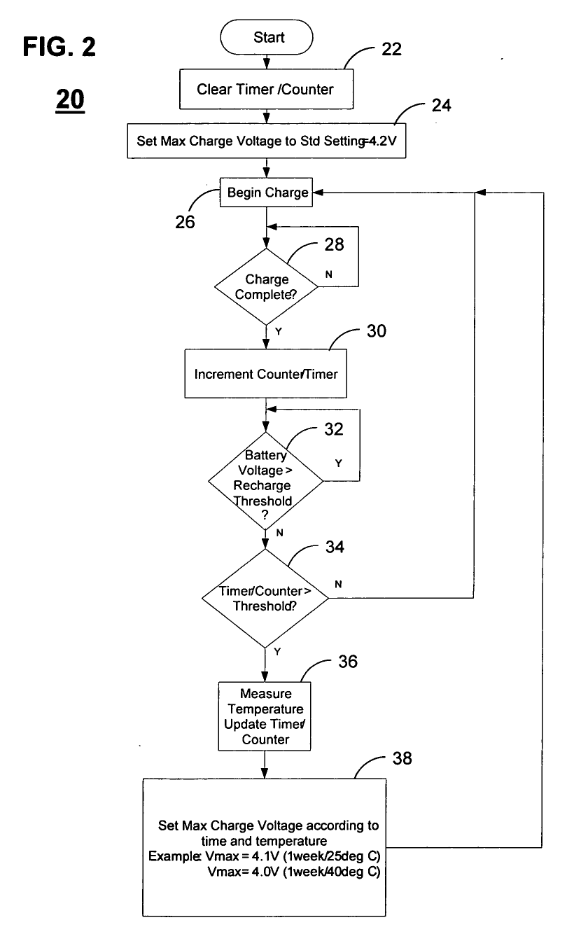

Referring to FIG. 2, a flow chart representing a proposed charging algorithm or method 20 in accordance with an embodiment of the present invention is shown. When a battery is attached to the charger, a timer and/or a charge cycle counter can be set to zero at step 22. At step 24, a maximum charge voltage (V max) can be set to an appropriate voltage, typically 4.2V, depending on the cell type (of the battery) and at step 26 the charging begins and continues until termination as determined by decision block 28. At this point, the charge cycle counter can be updated or incremented and/or the timer is started at step 30. As long as the battery voltage stays above a (recharge voltage) threshold at decision block 32, the charger remains unchanged. When the battery voltage falls below the recharge voltage threshold at decision block 32, then the method 20 proceeds to decision block 34 to determine if the timer or the counter failed to exceed a respective timer or counter threshold whereupon charging begins again at step 26 to bring the battery back up to Vmax or a full charge. The counter can be incremented at step 30 each time the charger begins again and/or the timer keeps track of how long the battery has been maintained at Vmax in the charger. After a pre-determined number of charge cycles and/or amount of time (timer/counter exceeding a timer/counter threshold) as determined at decision block 34 and when the battery voltage has fallen below the recharge threshold voltage at decision block 32, the charger will optionally measure the battery temperature at step 36 and set a new “cycle life optimized” Vmax for recharging at step 38. Subsequent recharge cycles will use this lower “cycle life optimized” Vmax, and the battery will be maintained at this lower voltage, but with an acceptable capacity. As an example, the cycle life optimized Vmax could be reset to 4.1 volts if the time interval estimated for maintaining the battery at a Vmax charge voltage is one week and the temperature measured is currently 25 degrees Celsius or the Vmax could be reset to 4.0 volts if the time interval is one week and the temperature is 40 degrees Celsius.

By dynamically adjusting the Vmax charge voltage based on the amount of time the battery is being maintained at the Vmax level and/or the amount of cycles the battery is charged to the Vmax threshold, the algorithm or method 20 is able to determine that the battery is an extended charged battery and can in turn dynamically adjust the Vmax threshold based on the aforementioned information. In addition, the method 20 can use the temperature that the battery is being charged at. In this fashion, the algorithm or method 20 can maintain the battery at an acceptable charge level while minimizing the cycle life affects of elevated voltage and temperature.

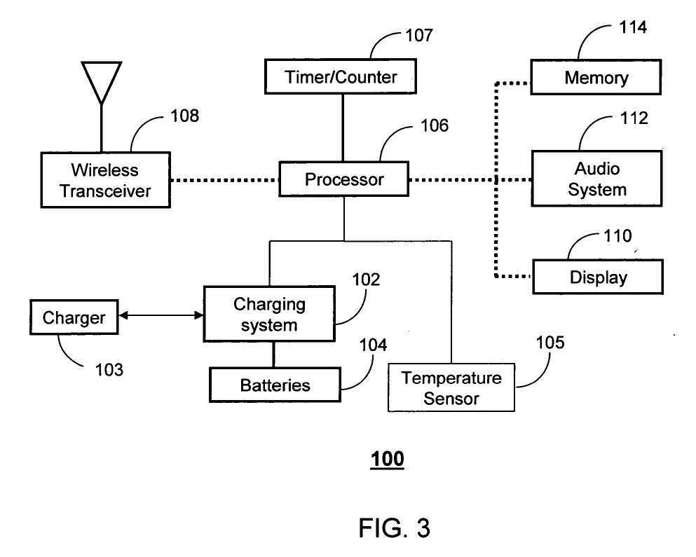

Referring to FIG. 3, a block diagram of a device 100 in accordance with an embodiment of the present invention is shown. The device 100 comprises a charging system 102 coupled to one or more batteries 104, a conventional real-time timer or counter 107 for tracking the amount of time a battery is being charge and/or for tracking a number of charging cycles, and a processor 106 coupled to the foregoing components for controlling operations thereof. The device 100 can further include a temperature sensor 105 for sensing the temperature of the battery during charging or after a charging cycle.

The charging system 102 includes, for example, a conventional regulation circuit (not shown) with conventional charge pumps if needed. The charging system 102 is coupled to the cells 104 for supplying an adjustable source voltage and/or source current for charging said cells 104 in accordance with the embodiments disclosed herein. To enable charging of the battery cells 104, a charger 103 is coupled to the charging system 102 to enabling charging in accordance with an algorithm or method 20 as described in the embodiments described above. Once the charger 103 and/or battery cells 104 are removed, charging of the battery cells 104 is done.

In a supplemental embodiment, the device 100 can include a conventional wireless transceiver 108 for exchanging messages with a communication system, a conventional display 110 for conveying interactive images to a user of the device 100, an audio system 112 for conveying audible signals to the user, and a conventional memory 114 for storage. The device 100 can further include a temperature sensor 105 to enable the measurement of the temperature of the battery. This embodiment can represent, for instance, a cell phone operating according to the present invention.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

1. A battery charging method, comprising the steps of:
determining that a battery is attached to a batters charger;
setting a maximum charge voltage for the battery; and
dynamically adjusting the maximum charge voltage for the battery while the batter is attached to the battery charger based on at least one among an amount of time the battery is maintained at the maximum charge voltage while attached to the battery charger and an amount of cycles the battery is charged to the maximum charge voltage while attached to the battery charger.

2. The method of claim 1, wherein the method further comprises the step of measuring a temperature of the battery while the battery is attached to the battery charger.

3. The method of claim 2, wherein the step of dynamically adjusting further comprises the step of dynamically adjusting the maximum charge voltage for the battery while the battery is attached to the battery charger in response to the temperature of the battery.

4. The method of claim 3, wherein the method further comprises the step of maintaining the battery at an acceptable charge level below the maximum charge voltage while minimizing cycle life effects of elevated voltage and temperature.

5. The method of claim 1, wherein the method further comprises the steps of:
setting to zero one among a counter and a timer; and
thereafter setting a threshold for the one among a counter and a timer that has been set to zero.

6. The method of claim 5, wherein the wherein the step of setting to zero comprises the step of clearing at least the one among the counter and the timer in response to one among the battery being removed from the battery charger and determining that the battery is attached to the battery charger.

7. The method of claim 1, wherein the method further comprises the step of updating at least one among a counter and a timer each time the battery is charged to the maximum charge voltage while attached to the battery charger.

8. A battery charging method, comprising the steps of:
setting a maximum charge voltage for a battery;
setting a threshold for at least one among a timer and a counter;
setting the at least one among the timer and the counter to zero for each time that the battery is coupled to a battery charger;
charging the battery to the maximum charge voltage;
incrementing the at least one among the timer and the counter when charging of the battery is complete;
repeating the charging and the incrementing steps while the battery is coupled to the battery charger in response to a battery voltage for the battery falling below a recharge voltage threshold and the at least one among the timer and the counter failing to exceed the threshold; and
adjusting the maximum charge voltage and repeating the charging and the incrementing steps while the battery is coupled to the batten charger in response to the battery voltage for the battery falling below the recharge voltage threshold and the at least one among the timer and the counter exceeding the threshold.

9. The method of claim 8, wherein the step of adjusting and repeating comprises the steps of, in response to the battery voltage falling below the recharge voltage threshold and the at least one among the timer and the counter exceeding the threshold:
measuring a temperature of the battery;
adjusting the maximum charge voltage; and
repeating the charging and the incrementing steps while the battery is coupled to the battery charger.

10. The method of claim 9, wherein the step of adjusting the maximum charge voltage comprises the step of adjusting the maximum charge voltage in response to a value of the at least one of the timer or the counter and the temperature measured.

11. The method of claim 8, wherein the step of adjusting and repeating comprises the step of adjusting the maximum charge voltage in accordance with a value of the at least one among the timer or the counter in response to the battery voltage falling below the recharge voltage threshold and the value of the at least one among the timer and the counter exceeding the threshold.

12. The method of claim 8, wherein the step of setting the at least one among the timer and the counter to zero comprises the step of clearing the at least one among the timer and the counter in response to detecting when the battery is coupled to the battery charger.

13. A battery charging system, comprising:
a charger coupleable to a battery;
at least one among a timer and a counter; and
a processor coupled to the at least one among the timer and the counter and coupleable to the charger, wherein the processor is programmed to:
detecting when the charger is coupled to the battery;
set a maximum charge voltage for the battery; and
dynamically adjust the maximum charge voltage for the battery in response to at least one among an amount of time the battery is maintained at the maximum charge voltage while coupled to the charger and an amount of cycles the battery is charged to the maximum charge voltage while coupled to the charger.

14. The battery charging system of claim 13, wherein the processor is further programmed to measure a temperature of the battery.

15. The battery charging method of claim 14, wherein the processor is further programmed to measure the temperature in response to the at least one among the timer and the counter exceeds a threshold value.

16. The battery charging system of claim 14, wherein the processor is further programmed to dynamically adjust the maximum charge voltage for the battery in response to the temperature of the battery measured.

17. The battery charging system of claim 16, wherein the processor is further programmed to maintain the battery at an acceptable charge level below the maximum charge voltage while minimizing cycle life effects of elevated voltage and temperature.

18. The battery charging system of claim 14, wherein the processor is further programmed to dynamically adjust the maximum charge voltage in response to at least one among a value of the timer, a value of the counter and the temperature measured.

19. The battery charging system of claim 13, wherein the processor is further programmed to clear the at least one among the timer and the counter in response to the processor detecting that the charger has coupled to the battery.

20. The battery charging system of claim 13, wherein the processor is further programmed to:
detecting when the charger is uncoupled from the battery; and
clearing the at least one among the timer and the counter in response to the processor detecting that the charger has been uncoupled from the battery.
